(19) United States
(12) Patent Application Publication
(10) Pub. No.: US 2019/0023208 A1
(43) Pub. Date: Jan. 24, 2019

(54) BRAKE PREDICTION AND ENGAGEMENT

(71) Applicant: Ford Global Technologies, LLC, Dearborn, MI (US)

(72) Inventors: Daniel Lewis Boston, Dearborn, MI (US); Kevin James Rhodes, Dearborn, MI (US); Nayaz Khalid Ahmed, Canton, MI (US)

(73) Assignee: Ford Global Technologies, LLC, Dearborn, MI (US)

(21) Appl. No.: 15/653,649

(22) Filed: Jul. 19, 2017

(51) Int. Cl. B60R 21/013; G06K 9/00; G06N 99/00; G06T 7/20

(52) U.S. Cl. CPC B60R 21/013; G06K 9/00315; G06K 2009/00328; G06T 7/20; G06N 99/005

(57) ABSTRACT

A computing device in a vehicle, programmed to predict a collision risk by comparing an acquired occupant facial expression to a plurality of stored occupant facial expressions, and, brake a vehicle based on the collision risk. The computing device can be programmed to predict a collision risk by determining a number of seconds until a negative event, including a collision, a near-miss, or vehicle miss-direction, is predicted to occur at a current vehicle trajectory.

### BACKGROUND

Vehicles can be equipped to operate in both autonomous and occupant piloted mode. Vehicles can be equipped with computing devices, networks, sensors and controllers to acquire information regarding the vehicle's environment and to pilot the vehicle based on the information. Safe and comfortable piloting of the vehicle can depend upon acquiring accurate and timely information regarding the vehicles' environment. Computing devices, networks, sensors and controllers can be equipped to analyze their performance, detect when information is not being acquired in an accurate and timely fashion, and take corrective actions including informing an occupant of the vehicle, relinquishing autonomous control or parking the vehicle.

### BRIEF DESCRIPTION OF THE DRAWINGS

FIG. 1 is a block diagram of an example vehicle.

FIG. 2 is a diagram of an example vehicle interior with an occupant and a video camera.

FIG. 3 is a diagram of an example occupant facial image with fiducial points.

FIG. 4 is a diagram of an example occupant facial image with fiducial points and edges.

FIG. 5 is a diagram of an example occupant facial image with fiducial points and edges.

FIG. 6 is a diagram of a convolutional neural network for processing facial expressions.

FIG. 7 is a flowchart diagram of an example process to acquire and process facial expressions to predict traffic events.

### DETAILED DESCRIPTION

Disclosed herein is a method, comprising, predicting a collision risk by comparing an acquired occupant facial expression to a plurality of previously acquired occupant facial expressions, and braking a vehicle based on the collision risk. The collision risk can be predicted by determining a number of seconds until a negative traffic event that includes a collision, a near-miss, or vehicle miss-direction is predicted to occur at a current vehicle trajectory, wherein the current vehicle trajectory includes a speed, a direction, and steering torque. The occupant facial expression can be acquired by acquiring video data including an occupant's face and extracting features from the video data that represent the occupant facial expression. Features can be extracted from the video data by determining an occupant's gaze direction and comparing the occupant's gaze direction with a direction to the negative traffic event, wherein comparing the occupant facial expression to the previously acquired occupant facial expressions includes processing the occupant facial expression with a machine learning program.

The previously acquired facial expressions can be associated with negative traffic events including their proximity in time to negative traffic events. The collision risk can be determined by comparing facial expressions with previously acquired facial expressions associated with their proximity in time to negative traffic events. The machine learning program can be trained by associating the previously acquired facial expressions with probabilities associated with their proximity in time to negative traffic events. The collision risk can be predicted by determining probabilities associated with negative traffic events with a trained machine learning program. The vehicle can be braked by pre-charging brakes or regenerative braking, wherein braking the vehicle by pre-charging brakes or regenerative braking is based on determining a medium collision risk. Braking the vehicle can include pre-charging brakes or regenerative braking and then applying braking torque, wherein braking the vehicle by pre-charging brakes or regenerative braking and then applying braking torque is based on determining a high collision risk.

Further disclosed is a computer readable medium storing program instructions for executing some or all of the above method steps. Further disclosed is a computer programmed for executing some or all of the above method steps, including a computer apparatus, programmed to compare an acquired occupant facial expression to a plurality of previously acquired occupant facial expressions, and brake a vehicle based on the collision risk. The computer can be further programmed to predict a collision risk by determining a number of seconds until a negative traffic event that includes a collision, a near-miss, or vehicle miss-direction is predicted to occur at a current vehicle trajectory, wherein the current vehicle trajectory includes a speed, a direction, and steering torque. The computer can be further programmed to acquire the occupant facial expression by acquiring video data including an occupant's face and extracting features from the video data that represent the occupant facial expression. Features can be extracted from the video data by determining an occupant's gaze direction and comparing the occupant's gaze direction with a direction to the negative traffic event, wherein comparing the occupant facial expression to the previously acquired occupant facial expressions includes processing the occupant facial expression with a machine learning program.

The computer can be further programmed to associate the previously acquired facial expressions with negative traffic events including their proximity in time to negative traffic events. The collision risk can be determined by comparing facial expressions with previously acquired facial expressions associated with their proximity in time to negative traffic events. The computer can be further programmed to train the machine learning program by associating the previously acquired facial expressions with probabilities associated with their proximity in time to negative traffic events. The collision risk can be predicted by determining probabilities associated with negative traffic events with a trained machine learning program. The computer can be further programmed to brake the vehicle by pre-charging brakes or regenerative braking, wherein braking the vehicle by pre-charging brakes or regenerative braking is based on determining a medium collision risk. Braking the vehicle can include pre-charging brakes or regenerative braking and then applying braking torque, wherein braking the vehicle by pre-charging brakes or regenerative braking and then applying braking torque is based on determining a high collision risk.

Vehicles can be equipped to operate in both autonomous and occupant piloted mode. By a semi- or fully-autonomous mode, we mean a mode of operation wherein a vehicle can be piloted by a computing device as part of a vehicle information system having sensors and controllers. The vehicle can be occupied or unoccupied, but in either case the vehicle can be piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering.

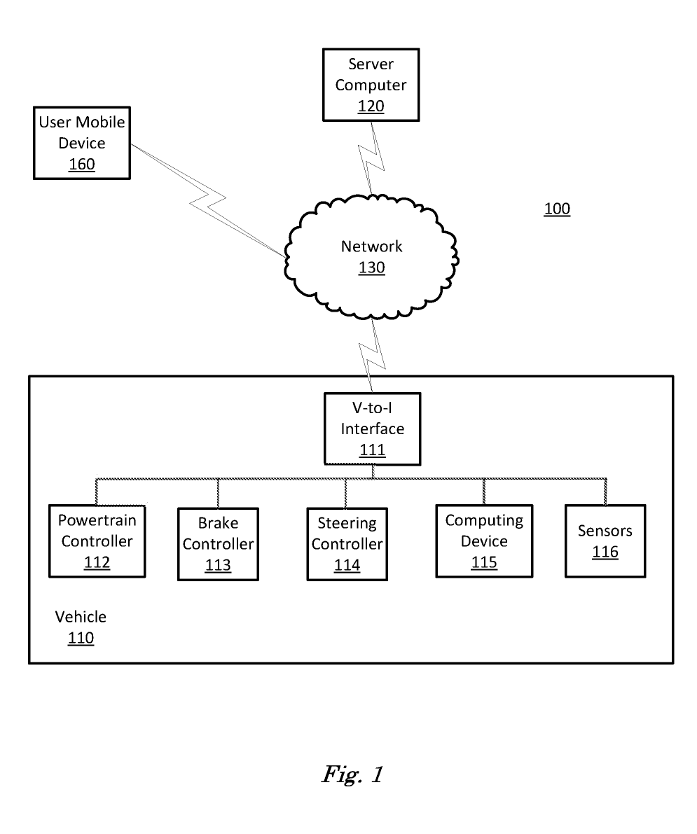

FIG. 1 is a diagram of a vehicle information system 100 that includes a vehicle 110 operable in autonomous (“autonomous” by itself in this disclosure means “fully autonomous”) and occupant piloted (also referred to as non-autonomous) mode in accordance with disclosed implementations. Vehicle 110 also includes one or more computing devices 115 for performing computations for piloting the vehicle 110 during autonomous operation. Computing devices 115 can receive information regarding the operation of the vehicle from sensors 116.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network such as a bus in the vehicle 110 such as a controller area network (CAN) or the like; the vehicle 110 network can include wired or wireless communication mechanism such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, may utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executed by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors such as speed, acceleration, deceleration, steering, etc., as well as tactical behaviors such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113 and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously.

The vehicle 110 is generally a land-based autonomous vehicle 110 having three or more wheels, e.g., a passenger car, light truck, etc. The vehicle 110 includes one or more sensors 116, the V-to-I interface 111, the computing device 115 and one or more controllers 112, 113, 114.

The sensors 116 may be programmed to collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating such as weather conditions, the grade of a road, the location of a road or locations of neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components and electrical and logical health of the vehicle 110.

In addition to operating in autonomous mode and occupant piloted mode, vehicle 110 can be operated in assisted occupant piloting mode, wherein computing device 115, receiving and analyzing information from sensors 116, can alert occupant of predicted impending negative traffic events, and, if occupant does not react to the alert, take control of vehicle 110 and direct controllers 112, 113, 114 to control steering, powertrain, and braking to avoid the negative traffic event. A negative traffic event is defined as an event that can occur while a vehicle 110 is being piloted that can cause the vehicle 110 to depart from an intended path by coming to a complete stop or slowing by more than 20% of the original speed or deviating from the intended path of the vehicle 110 by more than 50% of the width of the vehicle. For example, detecting an obstacle or other vehicle 110 in a roadway that can require a vehicle 110 to brake to avoid can represent a negative traffic event. Detecting an obstacle that can require vehicle 110 to deviate from an intended path more than 50% of the width of the vehicle 110 can also represent a negative traffic event, whether it also requires a change in vehicle 110 speed or not. For example, detecting an obstacle in a traffic lane can require a vehicle 110 to either change lanes to an open adjacent lane, or if an open adjacent lane is not available, employ hard braking to avoid a collision. Note that ranges described herein with respect to various widths and speeds are given by way of example, and not limitation, and that other widths and speeds are possible for the respective negative traffic events. To assist occupants in reacting to negative traffic events, a vehicle 110 can include a video-based machine vision system that tracks emotional states associated with responses to negative traffic events to be input to a machine-learning program that can be used to predict negative traffic events, for example.

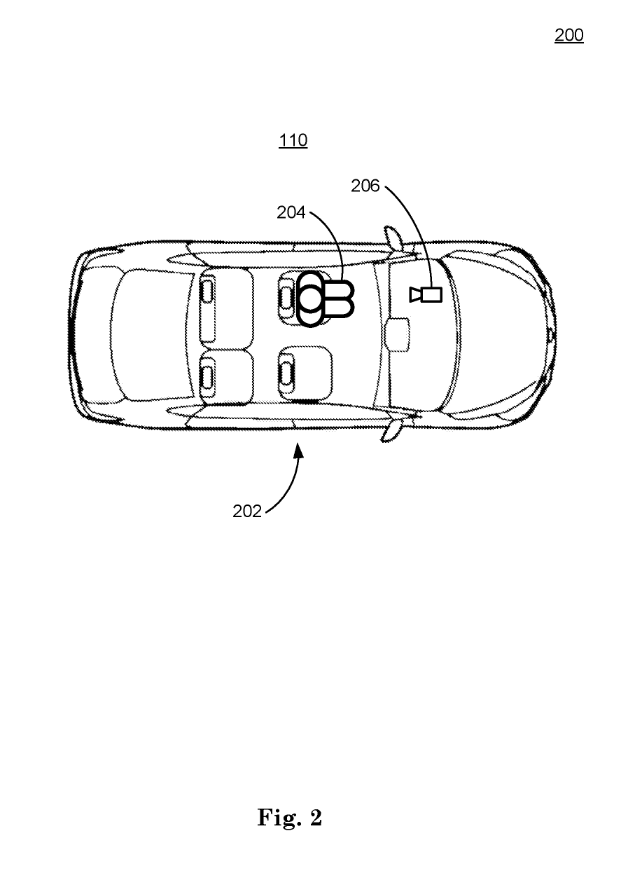

FIG. 2. is a diagram of a vehicle 200, shown in top-down, partial X-ray view to show the interior 202 of vehicle 200, including an occupant 204, and a video camera 206. The video camera 206 can be operatively connected to computing device 115 in such fashion as to permit computing device 115 to execute programming to perform facial recognition on video data input from video camera 206, and to output the results to a machine-learning program to detect changes in an occupant's facial expression, including surprise or fear, for example. Detecting surprise or fear in an occupant's facial expression can indicate that the occupant has predicted a potential negative traffic event. For example, an occupant can detect an obstacle in the path of vehicle 110 that requires hard braking. Hard braking can be defined as braking torque applied to the wheels of a vehicle 110 that slows the vehicle 110 to a complete stop or near complete stop wherein the negative acceleration of the vehicle 110 is equal to or greater than 0.5 standard gravity at any time during the braking. A machine-learning program can associate the preceding facial expression and eye responses, including gaze direction and pupil size, with events like hard braking events to build a profile of an occupant. The more events and facial expressions and eye responses computing device 115 acquires and inputs to the machine learning program, the more correlated and predictable the events, like hard braking, become, based on acquired facial expressions and eye responses. As a result, computing device 115 can adapt vehicle 110 to predict events like a hard braking event.

The machine learning program can determine a confidence level for predicting a hard braking event based on an acquired facial expression and eye response. For example, with a hard braking event determined with medium confidence based on an acquired facial expression and eye response, computing device 115 can pre-charge hydraulic brakes and, if available, increase regenerative braking to slow the vehicle as soon as an occupant indicates the beginning of a braking maneuver, by removing a foot from an accelerator pedal, for example. In general, confidence levels are assigned to ranges of probabilities that an even, e.g., a hard braking even, will occur. For example, a medium confidence level may be indicated when the probability that a hard braking event will be required is greater than 50% but less than 90%. Note that ranges described herein with respect to various confidence levels are given by way of example, and not limitation, and that other ranges are possible for the respective confidence levels.

In cases where a hard braking event is determined with high confidence, meaning that, for example, the probability that a hard braking event will be required with greater than 90% probability, computing device 115 can begin braking vehicle 110 automatically. The decision to begin braking vehicle 110 automatically can be combined with input from sensors 116, such as radar, LIDAR or video cameras used to detect obstacles. If both a machine learning program output based on acquired facial expression and eye response and output from sensors 116 predict a hard braking event, computing device 115 can begin braking sooner than basing the decision to begin braking on sensor 116 output alone.

Braking reaction time, which is defined as the time between an occupant perceiving a negative traffic event that can result in hard braking and the occupant applying braking, can vary between 0.7 seconds at the average minimum to about 4.0 seconds depending upon the level of alertness of the occupant. Facial expressions related to the perception of a hard braking event can become evident to facial recognition software in 0.3 seconds. This permits computing device 115 to reduce the time required to brake vehicle based on determined facial expressions acquired using a video camera 206 in a vehicle 110. Braking reaction time and collision risk can be predicted in response to negative traffic events including collisions, near-misses of collisions and vehicle 110 misdirection caused by avoiding a collision. Collisions, near-misses and vehicle 110 misdirections can be predicted by extrapolating a vehicle 110 future path based on a current vehicle 110 trajectory, where vehicle 110 trajectory includes speed and direction, and lateral acceleration due to steering torque.

In FIG. 2, video camera 206 in vehicle interior 202 can be configured to acquire images of an occupant 204 in sufficient detail to permit facial recognition software to determine facial expressions and eye responses of the occupant on a continuous basis as an occupant pilots vehicle 110. A machine learning program executing on computing device 115 can continuously determine an occupant's facial expression and thereby determine baseline facial expressions that occur in the absence of negative traffic events. When the machine learning program detects a facial expression that does not match a baseline facial expression, the machine learning program can try to compare the acquired facial expression with previously acquired facial expressions and determine a probability regarding a negative traffic event including hard braking, associated with the match. If the matched facial expression can be associated with a negative traffic event including hard braking with non-zero probability, computing device 115 can continue to monitor and match acquired facial expressions and update a probability associating the acquired facial expression with a hard braking event, for example. Once the determined probability exceeds predetermined thresholds for medium and high confidence, computing device 115 can pre-charge brakes, regenerative brake or apply brakes as discussed above.

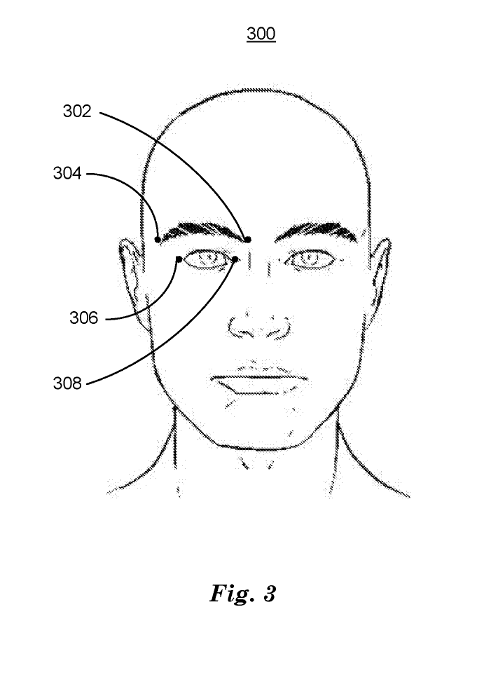

FIG. 3 is a diagram of an image of an occupant's face 300, with fiducial marks 302, 304, 306, 308 associated with features of the image of the occupant's face 300. Facial recognition software can associate fiducial marks with specific features common to most occupant's faces. For example, fiducial marks 302, 304 can be associated with an inner edge of an occupant's right eyebrow and an outer edge of an occupant's right eyebrow. Fiducial marks 306, 308 can also be associated with an inner edge of an occupant's right eye and an outer edge of an occupant's right eye. Fiducial marks 302, 304, 306, 308 can be reliably determined using machine vision techniques by computing device 115 on acquired video images of an occupant's face 300.

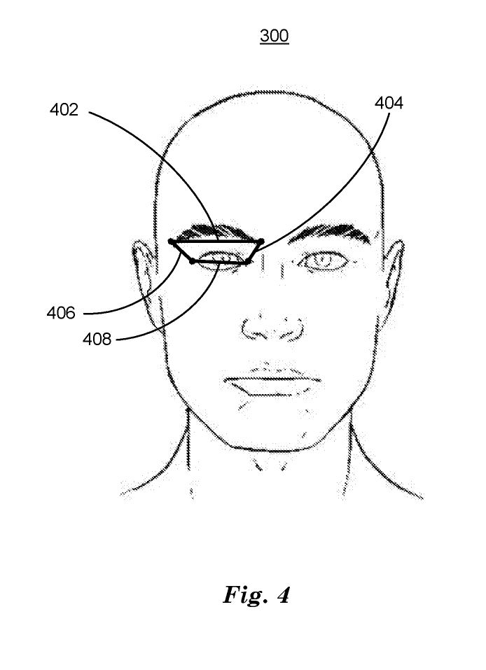

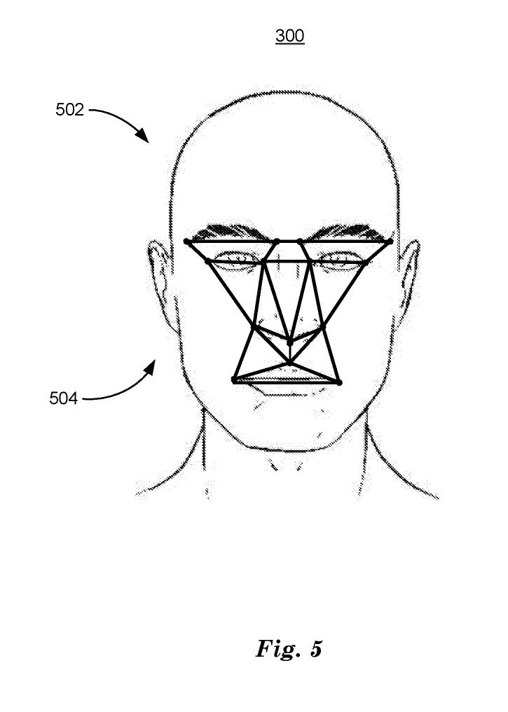

FIG. 4 is a diagram showing edges 402, 404, 406, 408 connecting fiducial marks 302, 304, 306, 308 associated with features of an image of an occupant's face 300. The edges 402, 404, 406, 408 can be analyzed using facial recognition programming executing on computing device 115 to determine lengths, angles and other relationships between edges 402, 404, 406, 408 which can be used to determine parameters that can be associated with an occupant's facial expression. FIG. 5 is a diagram showing a large set of fiducial points 502 connected by a large set of edges 504 associated with an image of an occupant's face 300. By determining a set of fiducial points 502 and a set of edges 504, computing device 115 executing facial recognition programming can extract facial parameters that correlate reliably and accurately with an occupant's facial expression. In this manner, computing device 115 can output an image that includes an occupant's facial expression represented as facial parameters that can be associated by subsequent processing by a machine learning program with emotions like fear and surprise reliably and accurately.

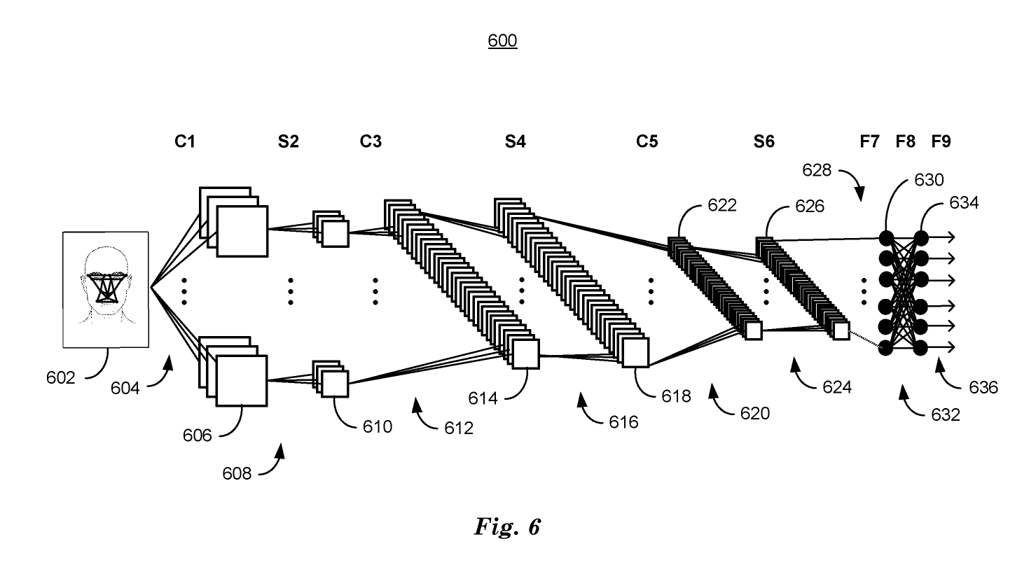

An acquiring an occupant's facial expression can also include acquiring an occupant's eye response. Occupant's eye response includes determining the direction of an occupant's gaze, or the direction in which an occupant is looking at a particular time. For example, computing device 115 can determine the direction of an occupant's gaze by determining the location and pose of the occupant's head and the location of the occupant's pupils with respect to the occupant's head. By determining the direction of an occupant's gaze with respect to a potential negative traffic event, computing device 115 can determine that an occupant is not reacting to a potential negative traffic event because the occupant is not looking in the appropriate direction. For example, if an occupant is looking down, into a vehicle 110 interior, to select a radio station or respond to a message on a cell phone, a stopped vehicle in the path of vehicle 110 can go unnoticed. In this case, computing device 115 can determine, with facial recognition programming and a machine learning program as described below in relation to FIG. 6, that a negative traffic event is imminent, and then apply braking.

FIG. 6 is a diagram of a machine learning program that can input an image including facial expressions 602 from a facial recognition program and output probabilities regarding impending negative traffic events including hard braking by comparing acquired input facial expressions 602 with previously acquired facial expression that have been associated with negative traffic events by processing acquired facial expressions with a trained convolutional neural network (CNN) 600. A CNN 600 can be a deep-learning, free-forward artificial neural network especially suited to solve image-based problems. A CNN 600 can be trained to determine probabilities that acquired facial expressions can be associated with negative traffic events, including hard braking, by inputting the facial expressions to a CNN 600 and training the CNN 660 by providing information regarding the behavior of an occupant and vehicle 110 associated with negative traffic events. Occupant and vehicle 110 behavior can be determined by computing device 115 by recording information from sensors 116 and controllers 112, 113, 114 while occupant is piloting a vehicle 110. For example, brake controller 113 can report the force and duration of braking to computing device 115, while sensors 116 can report the presence of obstacles in the path of vehicle 110. A CNN 600 can use this information as feedback to train CNN 600 to learn the association between facial expressions and the probability that a facial expression can be associated with a negative traffic event.

Training a CNN 600 can include information in the acquire facial expressions regarding an occupant's gaze. Occupant's gaze, including direction, is used to process the acquired facial expressions since, if it can be determined that the occupant is not looking in a direction that encompasses the impending negative traffic event, then the occupant's facial expression will not represent an occupant's reaction to the negative traffic event.

A CNN 600 is an example of a machine learning program that can “learn” an occupant's facial expressions by continuously acquiring video images of an occupant's face, processing the acquired video images to extract facial expressions with facial recognition software, and training the CNN 600 with acquired facial expressions and behavior recorded by computing device 115 as an occupant pilots a vehicle 110. The most common events recorded include “non-events,” where an occupant is piloting a vehicle 110 without addressing any exceptional events, such as a negative traffic event. In this case, the facial expressions are categorized as “baseline” facial expressions, and can be grouped together by CNN 600 and output by CNN 600 as a high probability of being a baseline facial expression. A facial expression input to CNN 600 can be classified as a baseline expression or as a facial expression that matches a previously trained group of facial expressions that occurred prior to or at the same time as a negative traffic event, including hard braking. In this example, CNN 600 can output a value that represents a proximity in time to an impending negative traffic event based on an acquired facial expression.

A CNN 600 can be a series of interconnected layers, where each layer can be either a convolutional layer C1, C3, and C5, a sub-sampling layer S2, S4, and S6 or a fully-connected layer F7 and F8. Convolutional layers C1, C3, and C5 form feature maps 606, 614, 622 from either input image of an occupant's facial expression 602, or, sub-sampled feature maps 610, 618 from a previous layer by convolution kernels 604, 612, 620. Feature maps 606, 614, 622 are outputs from 2D filters based on convolution kernels 604, 612, 620, determined through training as discussed above.

Sub-sampling layers S2, S4, and S6 sub-sample 608, 616, 624 the feature maps 606, 614, 622 to form feature maps 610, 618, 626 having fewer elements using max pooling to emphasize the most responsive points in the feature map. Max pooling forms an output by determining the maximum value over a window of an input image, and outputs the maximum value to represent the window in a correspondingly lower-resolution feature map. Max pooling can preserve feature information while deemphasizing position information, for example. Each convolutional/sub-sampling layer pair layers C1 and S2, C3 and S4, and C5 and S6 can filter with convolution kernels 604, 612, 620 and sub-sample 608, 616 624 input facial expression 602 and feature maps 606, 610, 614, 618, 622, 626 to lower resolution with smaller filter sizes while preserving features.

F7 is a fully-connected layer in which the feature maps 226 are converted 628 into a feature vector 630. F8 is another fully-connected layer, taking the feature vector 630 as input and generating a new feature vector 634. where each element of feature vector 634 represents the probabilities associated with a particular group of facial expressions, based on accumulated experience with an occupant. The probability function 632 that generates feature vector 634 can include Bayesian inference, where the probabilities included in feature vector 630 can be conditioned on known probabilities. For example, the majority of acquired facial expressions are likely to be associated with the baseline facial expression group. Bayesian inference can condition the output probability based on the knowledge that the majority of acquired facial expression belong to the group of baseline facial expressions, for example.

As CNN 600 processes facial parameters, computing device 115 can train CNN 600 by inputting, as feedback to the CNN 600 training process, a current behavioral state associated with an occupant piloting vehicle 110. In this example, the behavioral state can include recordings of “normal” or baseline piloting, where no exceptional traffic event is occurring, and recordings of occupant piloting behavior as a negative traffic event occurs. As CNN 600 becomes trained, the values output 636 from feature vector 634 are probabilities that represent the probability that input facial parameters predict either baseline behavior or proximity in time an impending negative traffic event, including hard braking.

Inputting a facial expression to a trained CNN 600 essentially compares the facial expression to facial expressions previously acquired and input to CNN 600, although CNN 600 does not actually store the previously acquired facial expressions as images. CNN 600 stores convolution kernels that can process input facial expressions identifying which group a facial expression belongs to. Grouping facial expressions into predetermined groups, like “baseline” and “fear and surprise,” can identify a facial expression more accurately and robustly than simply comparing images arithmetically. Training a CNN 600 to recognize facial expressions associated with negative traffic events can include supplying information regarding the proximity in time to negative traffic events at the time the facial expression was acquired.

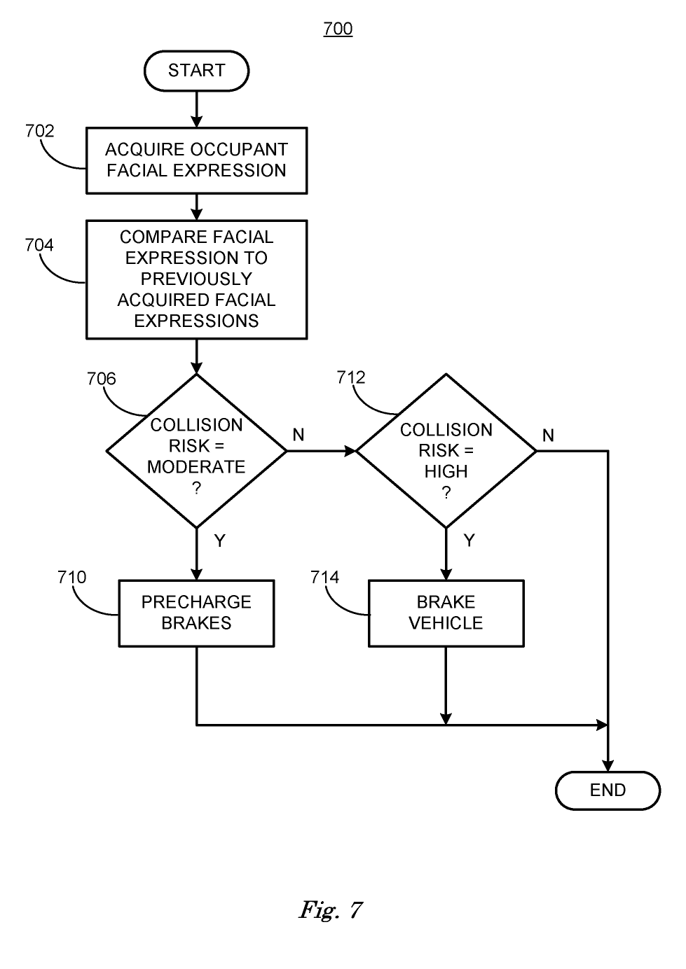

FIG. 7 is a diagram of a flowchart, described in relation to FIGS. 1-6, of a process 700 for braking prediction and engagement. Process 700 can be implemented by a processor of computing device 115, taking as input information from sensors 116, and executing instructions and sending control signals via controllers 112, 113, 114, for example. Process 700 includes multiple steps taken in the disclosed order. Process 700 also includes implementations including fewer steps or can include the steps taken in different orders.

Process 700 begins at step 702, where a computing device 115 in a vehicle 110 can acquire occupant facial expression as described above in relation to FIGS. 3-45 by acquiring a video image of an occupant's face, and processing the image with facial recognition software to extract facial parameters to form an image that represents an occupant's facial expression. At step 704, computing device 115 can input an acquired facial expression 602 to a machine learning program, in this example a trained CNN 600 to compare the facial expression 602 to previously acquired facial expressions that have been correlated with events that train CNN 600 to output probabilities associated with facial expressions as discussed above in relation to FIG. 6.

The probabilities output by CNN 600 in response to input acquired facial expression 602 can be tested at step 706 to determine whether the output probability represents a moderate collision risk by comparing the output 636 probabilities to predetermined values to determine if the output 636 probabilities represent a moderate collision risk. If the result is yes, at step 710 computing device can assist an occupant in reacting to the predicted imminent negative traffic event by pre-charging brakes, thereby reducing brake reaction time or to begin regenerative braking, if available, as soon as an occupant lifts his or her foot off an accelerator pedal. In the case where the output 636 probability is outside of the values predetermined to be associated with a moderate collision risk, at step 712 process 700 can determine if the output 636 probability is within the values predetermined to be associated with a high risk of collision. If the output 636 probability is consistent with a high risk of collision, computing device 115 can brake vehicle 110 by directing brake controller 113 to apply vehicle 110 brakes. In cases where the output 636 probability value is outside the values associated with either moderate or high risk of collision, process 700 ends.

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exact described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

We claim:

1. A method, comprising:
predicting a collision risk by comparing an acquired occupant facial expression to a plurality of previously acquired occupant facial expressions; and
braking a vehicle based on the collision risk.

2. The method of claim 1, further comprising predicting the collision risk by determining a number of seconds until a negative traffic event that includes a collision, a near-miss, or vehicle miss-direction is predicted to occur at a current vehicle trajectory.

3. The method of claim 2, wherein the current vehicle trajectory includes a speed, a direction, and steering torque.

4. The method of claim 3, further comprising acquiring the occupant facial expression by acquiring video data including an occupant's face and extracting features from the video data that represent the occupant facial expression.

5. The method of claim 4, further comprising extracting features from the video data including determining an occupant's gaze direction and comparing the occupant's gaze direction with a direction to the negative traffic event.

6. The method of claim 5, wherein comparing the occupant facial expression to the previously acquired occupant facial expressions includes processing the occupant facial expression with a machine learning program.

7. The method of claim 6, wherein the previously acquired facial expressions are associated with negative traffic events including their proximity in time to negative traffic events.

8. The method of claim 7, further comprising predicting the collision risk by comparing facial expressions with previously acquired facial expressions associated with their proximity in time to negative events.

9. The method of claim 1, further comprising braking the vehicle by pre-charging brakes or regenerative braking.

10. The method of claim 9, wherein braking the vehicle includes pre-charging brakes or regenerative braking and then applying braking torque.

11. A computer, programmed to:
predict a collision risk by comparing an acquired occupant facial expression to a plurality of previously acquired occupant facial expressions; and
brake a vehicle based on the collision risk.

12. The computer of claim 11, further programmed to predict the collision risk by determining a number of seconds until a negative traffic event that includes a collision, a near-miss, or vehicle miss-direction, is predicted to occur at a current vehicle trajectory.

13. The computer of claim 12, wherein the current vehicle trajectory includes a speed, a direction and steering torque.

14. The computer of claim 13, further programmed to acquire the occupant facial expression by acquiring video data including an occupant's face and extracting features from the video data that represent the occupant facial expression.

15. The computer of claim 14, further programmed to extract features from the video data including by determining an occupant's gaze direction and comparing the occupant's gaze direction with a direction to the negative traffic event.

16. The computer of claim 15, wherein comparing the occupant facial expression to the previously acquired occupant facial expressions includes processing the occupant facial expression with a machine learning program.

17. The computer of claim 16, programmed to associate the previously acquired facial expressions with negative traffic events based on their proximity in time to negative traffic events.

18. The computer of claim 17, further programmed to predict the collision risk by comparing facial expressions with previously acquired extracted features associated with their proximity in time to negative events.

19. The computer of claim 11, further programmed to brake the vehicle by pre-charging brakes or increasing brake regeneration.

20. The computer of claim 19, wherein brake the vehicle includes pre-charging brakes or increasing brake regeneration and then applying braking torque.
